(19) United States
(12) Patent Application Publication
(10) Pub. No.: US 2026/0275922 A1
(43) Pub. Date: Sep. 17, 2026

(54) SYSTEMS, METHODS, AND APPARATUS FOR PIEZOELECTRIC-BASED FUEL METERING AND FLOW CONTROL FOR AIRCRAFT ENGINES

(71) Applicants: General Electric Company, Evendale, OH (US); GE Avio S.r.l., Rivalta di Torino (IT)

(72) Inventors: Devaiah B B, Bengaluru (IN); Ashutosh Sinha, Bengaluru (IN); Ravindra Shankar Ganiger, Bengaluru (IN); Michael Joseph Murray, Wyoming, OH (US); Mirko Gernone, Bari (IT); David Raju Yamarthi, Bengaluru (IN)

(21) Appl. No.: 19/076,509

(22) Filed: Mar. 11, 2025

(51) Int. Cl. F02C 9/26; F02C 9/28

(52) U.S. Cl. CPC F02C 9/263; F02C 9/28; F05D 2220/323; F05D 2270/301; F05D 2270/303; F05D 2270/306; F05D 2270/62

(57) ABSTRACT

Systems, methods, and apparatus for piezoelectric-based metering and flow control for aircraft engines are disclosed herein. An example fuel metering system includes a piezoelectric metering device to meter a flow of a fuel, the piezoelectric metering device fluidly coupled to a pump and a fuel nozzle; a flow meter fluidly coupled between the piezoelectric metering device and the pump; a temperature sensor fluidly coupled between the piezoelectric metering device and the pump; and at least one processor circuit to: determine a mass flow rate of the fuel based on a pressure of the fuel, a first output of the flow meter, and a second output of the temperature sensor; and actuate the piezoelectric metering device based on the determined mass flow rate and a target mass flow rate.

### FIELD OF THE DISCLOSURE

This disclosure relates generally to fuel metering systems and, more particularly, to systems, methods, and apparatus for piezoelectric-based metering and flow control for aircraft engines.

### BACKGROUND

Typical aircraft propulsion systems include one or more gas turbine engines. For certain propulsion systems, the core of the gas turbine engine generally includes, in serial flow order, a compressor section, a combustion section, a turbine section, and an exhaust section. In operation, a fuel system provides flow of fuel to the combustion section of the engine, where the fuel is mixed with compressed air and burned within the combustion section to provide combustion gases. Typical fuel systems include one or more pumps that are driven by the turbo engine. The pump(s) increase the pressure of the fuel to ensure a sufficient flow rate of fuel is available to the combustion section of the engine.

### BRIEF DESCRIPTION OF THE DRAWINGS

FIG. 1 is a cross-sectional view of an example engine in which examples disclosed herein may be implemented.

FIG. 2 is schematic representation of an example piezoelectric-based fuel metering system that may be associated with the engine of FIG. 1 in accordance with the teachings of this disclosure.

FIG. 3 is a schematic representation of an alternative example piezoelectric-based fuel metering system that may be associated with the engine of FIG. 1 in accordance with the teachings of this disclosure.

FIG. 4 is a schematic representation of an alternative example piezoelectric-based fuel metering system that may be associated with the engine of FIG. 1 in accordance with the teachings of this disclosure.

FIG. 5 is a schematic representation of an alternative example piezoelectric-based fuel metering system that may be associated with the engine of FIG. 1 in accordance with the teachings of this disclosure.

FIG. 6 is a flowchart representative of an example process for metering fuel provided to a combustor using any of the example piezoelectric-based fuel metering systems of FIGS. 2-5 in accordance with the teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is, therefore, provided to describe example implementations and not to be taken limiting on the scope of the subject matter described in this disclosure. Certain features from different aspects of the following description may be combined to form yet new aspects of the subject matter discussed below.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, “upstream” and “downstream” refer to the relative direction with respect to fluid flow in a fluid pathway. For example, “upstream” refers to the direction from which the fluid flows and “downstream” refers to the direction to which the fluid flows.

Gas turbine engines, such as those used on aircraft, include a fuel system to supply a flow of fuel to the combustion section of the engine. Some known fuel systems include a pump to receive fuel from a fuel tank and increase the pressure of the fuel, and a control valve to regulate the flow of fuel to the combustor. In some known implementations, the fuel system is an open loop system, and/or includes a single control valve. Some known systems only regulate the fuel flow output from the control valve. These systems fail to provide precise metering of the fuel provided to the combustion section of the engine.

Example methods, systems, and apparatus disclosed herein achieve precise metering of fluid provided to a combustion section of a gas turbine engine. Example fuel metering systems include a piezoelectric metering device actuated by processor circuitry based on outputs from a measuring system including a flow meter and a temperature sensor. Example fuel metering systems include processor circuitry to control the piezoelectric metering device based on outputs of a first measuring system upstream of the piezoelectric measuring device (e.g., between a mechanical pumping system and the piezoelectric metering device). Example fuel metering systems provide closed-loop fuel metering by including a second measuring system downstream of the piezoelectric metering device (e.g., between the piezoelectric metering device and a combustor), the processor circuitry to adjust the piezoelectric metering device based on outputs of the second measuring system. Example fuel metering systems control a flow of fluid upstream of the measuring system by increasing or decreasing a speed of a motor of a pump. Example methods, systems, and apparatus disclosed herein precisely control the distribution of fuel provided to the combustion section across a number of nozzles. Fuel metering systems disclosed herein include a plurality of piezoelectric metering devices, which may be arranged in parallel, series, or both, actuated by processor circuitry based on a plurality of measuring systems to control the flow of fuel through the nozzles. Example fuel metering systems disclosed herein include a control valve in series with the piezoelectric metering device to control a flow provided to the piezoelectric metering device.

In some examples, fuel metering systems disclosed herein meter the flow of supercritical fuels such as, for example, hydrogen fuel. As used herein, a supercritical fuel is a fuel that is at a temperature and pressure above the critical point of the fuel and below the pressure required to compress the fuel into a solid. Aircraft fuel systems utilizing supercritical fuels experience high flow rate, pressure, and vibratory conditions, as well as low temperature conditions. Example fuel metering systems enable precise metering of supercritical fuels in such conditions.

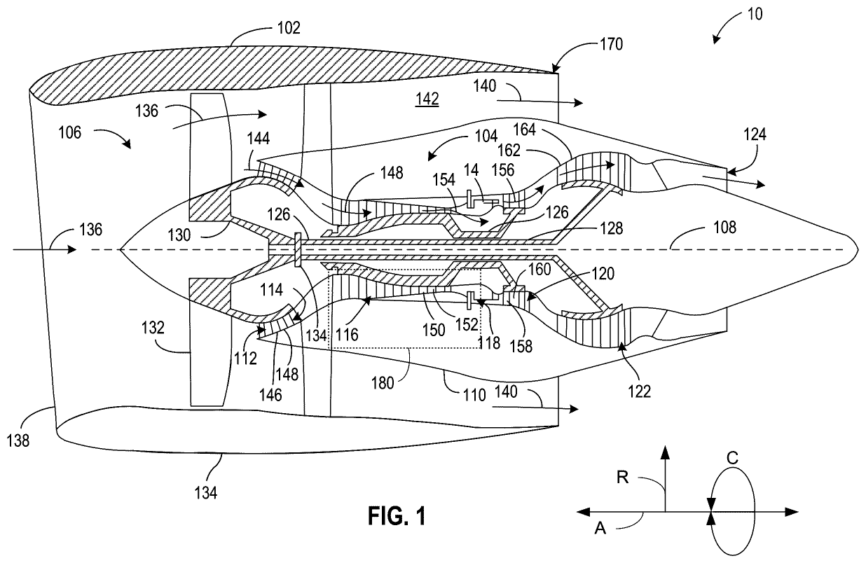

Referring now to the drawings, FIG. 1 is a schematic cross-sectional view of the example gas turbine engine 10 that can incorporate various examples disclosed herein. The example gas turbine engine 10 can be implemented on an aircraft and therefore referred to as an aircraft engine. In this example, the gas turbine engine 10 is a turbofan-type of engine. However, the principles of the present disclosure are also applicable to other types of engines, such as turboprop engines and engines without a nacelle, such as unducted fan (UDF) engines (sometimes referred to as propfans). Further, the examples disclosed herein can be implemented on other types of engines, such as non-aircraft engines, and/or power generators.

As shown in FIG. 1, the gas turbine engine 10 includes an outer bypass duct 102 (which may also be referred to as a nacelle, fan duct, or outer casing), a core turbine engine 104, and a fan section 106. The core turbine engine 104 and the fan section 106 are disposed at least partially in the outer bypass duct 102. The core turbine engine 104 is disposed downstream from the fan section 106 and drives the fan section 106 to produce forward thrust.

As shown in FIG. 1, the gas turbine engine 10 defines a longitudinal or axial centerline axis 108 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 108, the radial direction R is a direction that extends orthogonally outward from or inward toward the centerline axis 108, and the circumferential direction C is a direction that extends concentrically around the centerline axis 108.

The core turbine engine 104 includes a substantially tubular outer casing 110 (which may also be referred to as a mid-casing) that defines an annular inlet 112. The outer casing 110 of the core turbine engine 104 can be formed from a single casing or multiple casings. The outer casing 110 encloses, in serial flow relationship, a compressor section having a booster or low pressure compressor 114 (“LP compressor 114”) and a high pressure compressor 116 (“HP compressor 116”), a combustion section 118 (which may also be referred to as the combustor 118), a turbine section having a high pressure turbine 120 (“HP turbine 120”) and a low pressure turbine 122 (“LP turbine 122”), and an exhaust section 124.

The core turbine engine 104 includes a high pressure shaft 126 (“HP shaft 126”) that drivingly couples the HP turbine 120 and the HP compressor 116. The core turbine engine 104 also includes a low pressure shaft 128 (“LP shaft 128”) that drivingly couples the LP turbine 122 and the LP compressor 114. The LP shaft 128 also couples to a fan shaft 130.

The fan section 106 includes a plurality of fan blades 132 that are coupled to and extend radially outward from the fan shaft 130. In some examples, the LP shaft 128 may couple directly to the fan shaft 130 (i.e., a direct-drive configuration). In alternative configurations, the LP shaft 128 may couple to the fan shaft 130 via a reduction gear 134 (i.e., an indirect-drive or geared-drive configuration). While in this example the core turbine engine 104 includes two compressor and two turbines, in other examples, the core turbine engine 104 may only include one compressor and one turbine. Further, in other examples, the core turbine engine 104 can include more than two compressors and turbines. In such examples, the core turbine engine 104 may include more than two drive shafts or spools.

As illustrated in FIG. 1, during operation of the gas turbine engine 10, air 136 enters an inlet portion 138 of the gas turbine engine 10. The air 136 is accelerated by the fan blades 132. A first portion 140 of the air 136 flows into a bypass airflow passage 142, while a second portion 144 of the air 136 flows into the inlet 112 of the core turbine engine 104 (and, thus, into the LP compressor 114). Downstream of the inlet 112, one or more sequential stages of LP compressor stator vanes 146 and LP compressor rotor blades 148 coupled to the LP shaft 128 progressively compress the second portion 144 of the air 136 flowing through the LP compressor 114 en route to the HP compressor 116. Next, one or more sequential stages of HP compressor stator vanes 150 and HP compressor rotor blades 152 coupled to the HP shaft 126 further compress the second portion 144 of the air 136 flowing through the HP compressor 116. This provides compressed air 154 to the combustion section 118 where it mixes with fuel and burns to provide combustion gases 156. The gas turbine engine 10 includes a fuel metering system 12 (not shown) to provide pressurized fuel through the fuel nozzles 14 to the combustion section 118 of the core turbine engine 104. Example fuel metering systems 12 to control the flow of fuel to the combustion section 118 are disclosed herein.

The example fuel metering system 12 is positioned inside the gas turbine engine 10 in a region indicated by dashed box 180. In other examples, the fuel metering system 12 can be positioned elsewhere (e.g., outside the gas turbine engine 10, another location within the gas turbine engine 10, etc.). In some examples, the fuel metering system 12 is located inside a core cowl of the gas turbine engine 10. In other examples, the fuel metering system 12 is positioned in the fan cowl of the gas turbine engine 10.

The combustion gases 156 flow through the HP turbine 120 where one or more sequential stages of HP turbine stator vanes 158 and HP turbine rotor blades 160 coupled to the HP shaft 126 extract a first portion of kinetic and/or thermal energy. This energy extraction supports operation of the HP compressor 116. The combustion gases 156 then flow through the LP turbine 122 where one or more sequential stages of LP turbine stator vanes 162 and LP turbine rotor blades 164 coupled to the LP shaft 128 extract a second portion of thermal and/or kinetic energy therefrom. This energy extraction causes the LP shaft 128 to rotate, which supports operation of the LP compressor 114 and/or rotation of the fan shaft 130. The combustion gases 156 then exit the core turbine engine 104 through the exhaust section 124 thereof. The combustion gases 156 mix with the first portion 140 of the air 136 from the bypass airflow passage 142. The combined gases exit an exhaust nozzle 170 (e.g., a converging/diverging nozzle) of the bypass airflow passage 142 to produce propulsive thrust.

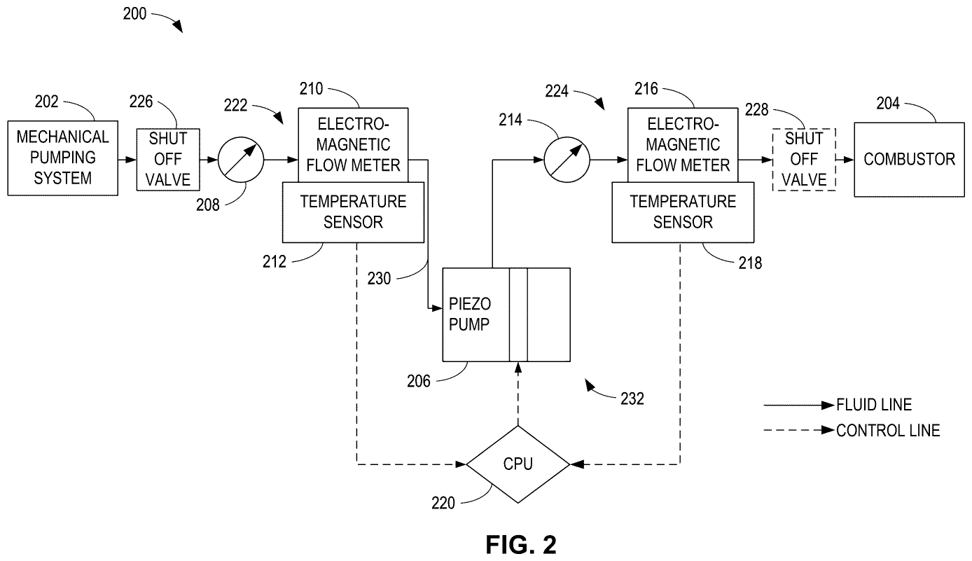

FIG. 2 is schematic representation of an example piezoelectric-based fuel metering system (PMS) 200 that can implement the fuel metering system 12 of FIG. 1. The PMS 200 includes a pumping system 202, a combustor 204, a piezoelectric metering device 206, a first pressure gauge 208, a first flow meter 210, a first temperature sensor 212, a second pressure gauge 214, a second flow meter 216, a second temperature sensor 218, and processor circuitry 220. In some examples, the first pressure gauge 208, the first flow meter 210, and the first temperature sensor 212 provide a first measuring system 222, and the second pressure gauge 214, the second flow meter 216, and the second temperature sensor 218 provide a second measuring system 224. The PMS 200 further includes a first shut off valve 226 and a second shut off valve 228.

The PMS 200 includes one or more conduits 230 to fluidly couple the pumping system 202, the combustor 204, the piezoelectric metering device 206, the first pressure gauge 208, the first flow meter 210, the first temperature sensor 212, the second pressure gauge 214, the second flow meter 216, and the second temperature sensor 218. Accordingly, the conduits 230 define a fuel path 232 in which the direction of the fuel within the fuel path 232 is designated by arrowheads. In the illustrated example of FIG. 2, the fuel flows from left to right. In the illustrated example, the fuel enters the fuel path 232 at the pumping system 202 and flows from the pumping system 202 to the combustor 204 via the piezoelectric metering device 206. The pumping system 202 provides fuel through the fuel path 232. The fuel enters the first shut off valve 226. The first shut off valve 226 is operable to cut off the flow of fuel to the downstream components of the PMS 200.

After flowing through the first shut off valve 226, the fuel passes through and/or across the first pressure gauge 208. The first pressure gauge 208 measures a pressure of the fuel at the first pressure gauge 208. In some examples, the first pressure gauge 208 outputs the measured pressure of the fuel at the first pressure gauge 208 (e.g., a pressure gauge output, a first output, a second output, etc.) to the processor circuitry 220.

The fuel then flows through and/or across the first flow meter 210 and the first temperature sensor 212. The first flow meter 210 is used to calculate a first volumetric flow rate of the fuel flowing through the first flow meter 210. In some examples, the first flow meter 210 outputs a first flow meter output (e.g., a first output, a second output, etc.) to the processor circuitry 220. The first flow meter output can include at least one of the first volumetric flow rate, a velocity of the fuel passing through the first flow meter 210, or a cross-sectional area of a passage of the first flow meter 210.

The first temperature sensor 212 measures a temperature of the fuel flowing through the first flow meter 210. In some examples, the first temperature sensor 212 outputs the temperature (e.g., a temperature sensor output, a first output, a second output, etc.) to the processor circuitry 220.

After passing through the first flow meter 210 and flowing through and/or across the first temperature sensor 212, the fuel enters the piezoelectric metering device 206. The piezoelectric metering device 206 is operated to control the flow rate of fuel provided to the combustor 204. In the illustrated example of FIG. 2, the piezoelectric metering device 206 is a diaphragm-based piezoelectric pump. In other examples, the piezoelectric metering device 306 is another type of piezoelectric metering device (e.g., a stack-based piezoelectric metering device).

The fuel exiting the piezoelectric metering device 206 flows through and/or across the second pressure gauge 214, the second flow meter 216, and the second temperature sensor 218. The second pressure gauge 214 measures the pressure of the fuel at the second pressure gauge 214. In some examples, the second pressure gauge outputs the measured pressure of the fuel (e.g., a pressure gauge output, a first output, a second output, etc.) to the processor circuitry 220.

The fuel then flows through and/or across the second flow meter 216 and the second temperature sensor 218. The second flow meter 216 is used to calculate a second volumetric flow rate of the fuel flowing through the second flow meter 216. In some examples, the second flow meter 216 outputs a second flow meter output (e.g., a first output, a second output, etc.) to the processor circuitry 220. The second flow meter output can include at least one of the second volumetric flow rate, a velocity of the fuel passing through the second flow meter 216, or a cross-sectional area of a passage of the second flow meter 216.

The second temperature sensor 218 measures a temperature of the fuel flowing through the second flow meter 216. In some examples, the second temperature sensor 218 outputs the temperature (e.g., a temperature sensor output, a first output, a second output, etc.) to the processor circuitry 220. The fuel then flows to the second shut off valve 228, which is operable to cut off the flow of fuel to the combustor 204. The fuel is then delivered to the combustor 204.

In the illustrated example of FIG. 2, the first flow meter 210 and the second flow meter 216 are electromagnetic flow meters. The electromagnetic flow meters generate a magnetic field through which the fuel flows through. The electromagnetic flow meters include a sensor to capture the voltage of the fuel as it flows through the magnetic field. In some examples, the electromagnetic flow meters convert the voltage into a flow measurement and output the flow measurement to the processor circuitry 220. In some examples, the first flow meter 210 and/or the second flow meter 216 are implemented by a type of flow meter other than an electromagnetic flow meter (e.g. an ultrasonic flow meter, a turbine flow meter, vortex flow meter, positive displacement flow meter, etc.).

The example piezoelectric metering device 206 is a diaphragm-based piezoelectric pump. The diaphragm-based piezoelectric pump includes a piezoelectric element, a power source, a passage for fuel flow, and a diaphragm disposed at least partially in the passage. The power source is controlled to deliver electrical signals to the piezoelectric element, which actuates the diaphragm in response to the electrical signals. The electrical signals cause the piezoelectric element to expand or contract, adjusting the position of the diaphragm and thereby controlling the rate of fuel flow through the piezoelectric metering device 206. The amplitude and frequency of the electrical signals delivered to the piezoelectric element enable fine control of the behavior of the diaphragm. The piezoelectric metering device 206 also enables an increase in pressure of the fuel that passes through the piezoelectric metering device 206 that is not achievable with a control valve. Thus, the piezoelectric metering device acts as both a pressure regulator and a flow regulator.

In the illustrated example of FIG. 2, the processor circuitry 220 is communicatively coupled to the first measuring system 222, the second measuring system 224, and the piezoelectric metering device 206. In some examples, the processor circuitry 220 is further coupled to the first shut off valve 226, the second shut off valve 228, and/or the pumping system 202. The processor circuitry 220 receives the first pressure gauge output, the first flow meter output, and the first temperature sensor output. The processor circuitry 220 causes actuation of the piezoelectric metering device 206 based on the first pressure gauge output, the first flow meter output, and the first temperature sensor output.

In some examples, the processor circuitry 220 determines a first flow rate based on the first pressure gauge output, the first flow meter output, and the first temperature sensor output. In some examples, the first flow rate is the first volumetric flow rate and/or the first mass flow rate. For example, the processor circuitry 220 determines the first volumetric flow rate based on the velocity of the fuel measured by the first flow meter 210 and the cross-sectional area of the passage of the first flow meter 210.

In some examples, the processor circuitry 220 determines the first mass flow rate based on the first volumetric flow rate, the first pressure gauge output, and the first temperature output. For example, the processor circuitry 220 calculates the first mass flow rate by determining a density of the fuel based on the first pressure gauge output and the first temperature output, respectively, and multiplying the density by the first volumetric flow rate. The processor circuitry 220 then actuates the piezoelectric metering device 206 based on the first flow rate. For example, the processor circuitry 220 actuates the piezoelectric metering device 206 based on the first volumetric flow rate and/or the first mass flow rate.

In some examples, the processor circuitry 220 compares the first flow rate to a target flow rate. For example, the processor circuitry 220 compares at least one of the first volumetric flow rate and/or the first mass flow rate to a corresponding target volumetric flow rate and/or target mass flow rate. In some examples, the target volumetric flow rate and/or the target mass flow rate is determined based on a thrust demand, a flow rate of air provided to the combustor, a number of fuel nozzles providing fuel to the combustor, the type of fuel, the type of engine, a flight stage (also referred to as a mission point) of a jet engine cycle (e.g., take-off, cruise, descent, etc.), etc. In some examples, the target flow rate is determined primarily by the thrust demand.

Based on a difference between the first flow rate and the first target flow rate, the processor circuitry 220 actuates the piezoelectric metering device 206 to one of increase or decrease the flow rate to achieve the target volumetric flow rate and/or the target mass flow rate. For example, the processor circuitry 220 actuates the piezoelectric metering device based on a difference between first volumetric flow rate and the target volumetric flow rate, and/or a difference between the first mass flow rate and the target mass flow rate.

The processor circuitry 220 controls the flow rate provided to the combustor 204 by controlling the frequency at which the piezoelectric metering device 206 vibrates. The processor circuitry 220 determines a desired change in flow rate, based on the first flow rate and the target flow rate, and determines a frequency at which to vibrate the diaphragm of the piezoelectric metering device 206 to achieve the desired change in flow rate. In some examples, the frequency is determined according to calculations based on the physical properties of the piezoelectric metering device 306 and the target flow rate. In other examples, the processor circuitry 220 determines the frequency according to stored values (e.g., a look up table, a data store, etc.). The processor circuitry 220 sends a signal to the piezoelectric metering device 206 to cause the diaphragm of the piezoelectric metering device 206 to vibrate at the frequency. In some examples, the processor circuitry 220 compares the difference(s) to tolerance threshold(s). In some examples, the difference(s) compared by the processor circuitry 220 include the difference between first volumetric flow rate and the target volumetric flow rate, and/or the difference between the first mass flow rate and the target mass flow rate. In such examples, the processor circuitry 220 causes actuation of the piezoelectric metering device 206 if the difference(s) exceed the tolerance threshold(s). For example, if the first mass flow rate is 20 kg/sec higher than the target mass flow rate and the tolerance threshold is 10 kg/sec, the processor circuitry 220 causes actuation of the piezoelectric metering device 206.

In those examples, if the difference(s) falls within the tolerance threshold(s), the processor circuitry 220 does not actuate the piezoelectric metering device 206 to change the flow rate. For example, if the first mass flow rate is 5 kg/sec higher than the target mass flow rate and the tolerance threshold is 10 kg/sec, the processor circuitry 220 does not cause actuation of the piezoelectric metering device 206.

The processor circuitry 220 receives the second pressure gauge output, the second flow meter output, and the second temperature sensor output. The processor circuitry 220 causes actuation of the piezoelectric metering device 206 based on the second pressure gauge output, the second flow meter output, and the second temperature sensor output. Thus, the second measuring system 224 and the processor circuitry 220 form a closed feedback loop mechanism to ensure the piezoelectric metering device 206 is operating correctly and to fine-tune the control of the fuel flow provided to the combustor 204. In some examples, the processor circuitry 220 determines a second flow rate based on the second pressure gauge output, the second flow meter output, and the second temperature sensor output. In some examples, the second flow rate is the second volumetric flow rate and/or the second mass flow rate. The processor circuitry 220 then actuates the piezoelectric metering device 206 based on the second flow rate.

In some examples, the processor circuitry 220 compares the second flow rate to the target flow rate. For example, the processor circuitry 220 compares at least one of the second volumetric flow rate and/or the second mass flow rate to the corresponding target volumetric flow rate and/or target mass flow rate. Based on a difference between the second flow rate and the target flow rate, the processor circuitry 220 actuates the piezoelectric metering device 206 to one of increase or decrease the flow rate to achieve the target flow rate. For example, the processor circuitry 220 actuates the piezoelectric metering device 206 based on a difference between the second volumetric flow rate and the target volumetric flow rate, and/or a difference between the second mass flow rate and the target mass flow rate. In some examples, the processor circuitry 220 adjusts the piezoelectric metering device 206 based on both a first difference between a first flow rate and a first target flow rate and a second difference between a second flow rate and a second target flow rate.

In some examples, the processor circuitry 220 compares the difference(s) to a tolerance threshold(s) as described above. In some cases, the same tolerance threshold(s) is used with the first volumetric flow rate and first mass flow rate, and the second volumetric flow rate and second mass flow rate. In other examples, different tolerance threshold(s) are used for the first volumetric flow rate and first mass flow rate than the tolerance threshold(s) used for the second volumetric flow rate and second mass flow rate.

In the illustrated example of FIG. 2, the first measuring system 222 is located upstream of the piezoelectric metering device 206 and the second measuring system 224 is located downstream of the piezoelectric metering device 206. In some examples, the PMS 200 includes only one of the first measuring system 222 or the second measuring system 224. In some examples, the PMS 200 does not include the first or second shut off valves 226, 228. In some examples, the first measuring system 222, the piezoelectric metering device 206, and the second measuring system 224 provide a first fuel line and the PMS 200 includes a plurality of fuel lines fluidly coupled to the pumping system 202 and the combustor 204. In some examples, the PMS 200 includes a control valve to control the flow rate of fuel provided to the piezoelectric metering device 206.

In the illustrated example, the first pressure gauge 208 is separate from the first flow meter 210 and the first temperature sensor 212, and the second pressure gauge 214 is separate from the second flow meter 216 and the second temperature sensor 218. In some examples, the first pressure gauge 208 is integral with the first flow meter 210 and/or the first temperature sensor 212, and/or the second pressure gauge 214 is integral with the second flow meter 216 and/or the second temperature sensor 218.

In the illustrated example of FIG. 2, the first flow meter 210 and the first temperature sensor 212 are an integral component and the second flow meter 216 and the second temperature sensor 218 are an integral component. In some examples, first flow meter 210 and the first temperature sensor 212 are distinct elements, and/or the second flow meter 216 and the second temperature sensor 218 are distinct elements.

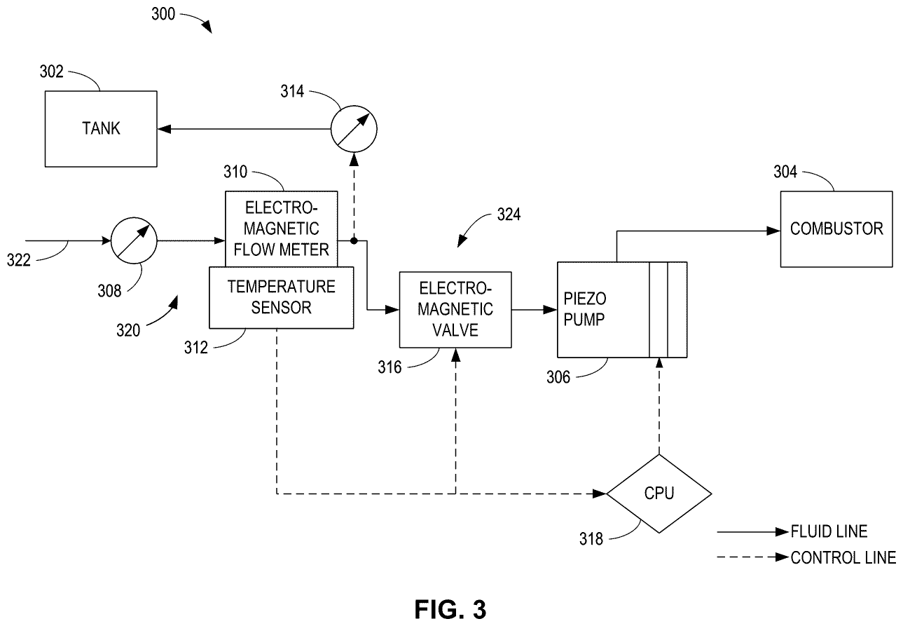

FIG. 3 is a schematic representation of an alternative example piezoelectric-based fuel metering system 300 that can implement the fuel metering system 12 of FIG. 1. The PMS 300 includes a fuel tank 302, a combustor 304, a piezoelectric metering device 306, a pressure gauge 308, a flow meter 310, a temperature sensor 312, a pressure relief valve 314, a control valve 316, and processor circuitry 318.

The pressure gauge 308, the flow meter 310, and the temperature sensor 312 may be collectively referred to as a measuring system 320. The PMS 300 includes one or more conduits 322 to fluidly couple the fuel tank 302, the combustor 304, the piezoelectric metering device 306, the pressure gauge 308, the flow meter 310, the temperature sensor 312, the pressure relief valve 314, and the control valve 316. Accordingly, the conduits 322 define a fuel path 324 in which the direction of the fuel within the fuel path 324 is designated by arrowheads. In the illustrated example of FIG. 3, the fuel flows from left to right from the pressure gauge 308 to the combustor 304.

The fuel enters the fuel path 324 and flows through and/or across the pressure gauge 308, the flow meter 310, and the temperature sensor 312. The operation of the pressure gauge 308, the flow meter 310, and the temperature sensor 312 is similar to the operation of the first and second pressure gauges 208, 214, the first and second flow meters 210, 216, and the first and second temperature sensors 212, 218, as discussed above in connection with FIG. 2.

The fuel then flows through and/or across the pressure relief valve 314. The pressure relief valve 314 operates to direct fuel out of the PMS 300 and back to a fuel tank 302 if the pressure of the flow of fuel at the pressure relief valve 314 exceeds a threshold pressure relief value (e.g., 200 psi, 215 psi, etc.). By preventing the pressure from exceeding the threshold pressure relief value, the components of the PMS 300 are protected from damage that may result from high pressures. In some examples, the threshold pressure relief value is determined based on maximum pressure tolerances of the PMS 300 components.

The fuel that remains in the PMS 300 proceeds to the control valve 316. The control valve 316 is operated to control the flow rate of fuel provided to the piezoelectric metering device 306. In the illustrated example of FIG. 3, the control valve 316 is an electromagnetic control valve. In other examples, the control valve 316 is implemented by another type of control valve. The fuel enters the piezoelectric metering device 306, which is operable to fine tune the flow characteristics of the fuel provided to the combustor 304 downstream.

The example piezoelectric metering device 306 is a stack-based piezoelectric pump. The stack-based piezoelectric pump includes a multi-layer stack of piezoelectric elements, a power source, a passage for fuel flow, and a valve element. The power source is controlled to deliver electrical signals to the multi-layer stack of piezoelectric elements, which expand or contract in response to the signal from the power source. The expansion or contraction of the multi-layer stack of piezoelectric elements actuates the valve element, controlling the rate of fuel flow through the piezoelectric metering device 306. The stack-based piezoelectric pump enables precise and rapid fine-tuning of the fuel flow rate through the pump. In other examples, the piezoelectric metering device 306 is another type of piezoelectric metering device (e.g., a diaphragm-based piezoelectric metering device).

In the illustrated example of FIG. 3, the processor circuitry 318 is communicatively coupled to the measuring system 320, the control valve 316, and the piezoelectric metering device 306. The processor circuitry 318 receives a pressure gauge output, a flow meter output, and a temperature sensor output. The processor circuitry 318 causes actuation of the control valve 316 and the piezoelectric metering device 306 based on the pressure gauge output, the flow meter output, and first temperature sensor output, to achieve a target volumetric flow rate and/or a target mass flow rate. In some examples, the processor circuitry 318 determines a volumetric flow rate and/or a mass flow rate of the fuel based on the pressure gauge output, the flow meter output, and the temperature sensor output, as described in connection with FIG. 2.

In some examples, the processor circuitry 318 actuates the control valve 316 based on a first tolerance threshold(s) corresponding to the control valve 316 and actuates the piezoelectric metering device 306 based on a second tolerance threshold(s) corresponding to the piezoelectric metering device 306. In some examples, the first tolerance threshold(s) is different than the second tolerance threshold(s).

In some examples, the processor circuitry 318 performs coarse adjustments to the flow rate by actuating the control valve 316 and performs fine adjustments to the flow rate by actuating the piezoelectric metering device 306. For example, if a target mass flow rate is 47.5% of the determined mass flow rate, the processor circuitry 318 actuates the control valve 316 to reduce the flow rate by 50% and actuate the piezoelectric metering device 306 to reduce the flow from the control valve 316 by an additional 5%. The processor circuitry 318 determines a total flow rate adjustment required, a first flow rate adjustment to be performed by the control valve 316, and a second flow rate adjustment to be performed by the piezoelectric metering device 306. In some examples, the processor circuitry 318 determines the first flow rate adjustment and the second flow rate adjustment based on a target percentage (e.g., 5 percent, 10 percent, 15 percent, 20 percent, etc.) of the total flow adjustment that is to be performed by the piezoelectric metering device 306. In some examples, the processor circuitry 318 is not communicatively coupled to the control valve 316 and the control valve 316 is operated separate from the piezoelectric metering device 306.

In some examples, the measuring system 320 is a first measuring system 320 and the PMS 300 includes a second measuring system fluidly coupled between the control valve 316 and the piezoelectric metering device 306, and/or a third measuring system fluidly coupled between the piezoelectric metering device 306 and the combustor 304. In such examples, the processor circuitry is communicatively coupled to the second measuring system and/or the third measuring system.

The processor circuitry 318 receives outputs from the second and third measuring systems and causes actuation of the control valve 316 and the piezoelectric metering device 306 based on the outputs. Thus, the second measuring system and the processor circuitry 318 form a closed feedback loop mechanism to ensure the control valve 316 is operating correctly and the third measuring system and the processor circuitry 318 form a closed feedback loop mechanism to ensure the piezoelectric metering device 306 is operating correctly.

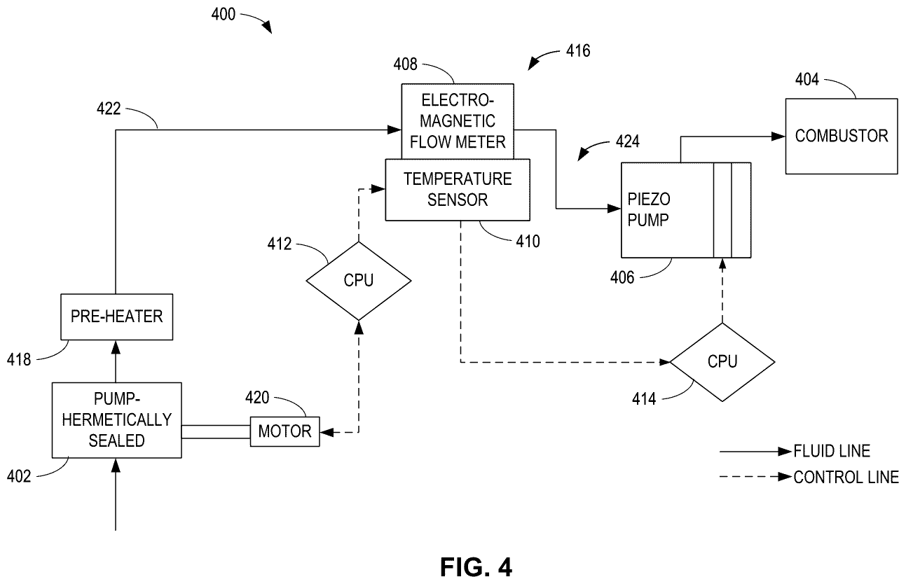

FIG. 4 is a schematic representation of an alternative example piezoelectric-based fuel metering system 400 that can implement the fuel metering system 12 of FIG. 1. The PMS 400 includes a pump 402, a combustor 404, a piezoelectric metering device 406, a flow meter 408, a temperature sensor 410, first processor circuitry 412, and second processor circuitry 414. The flow meter 408 and the temperature sensor 410 may be collectively referred to as a measuring system 416. The PMS 400 also includes a pre-heater 418 to heat the fuel from the pump 402. The example pump 402 is a hermetically-sealed pump 402 including a motor 420. The PMS 400 includes one or more conduits 422 to fluidly couple the pump 402, the combustor 404, the piezoelectric metering device 406, the flow meter 408, and the temperature sensor 410. Accordingly, the conduits 422 define a fuel path 424 in which the direction of the fuel within the fuel path 424 is designated by arrowheads. In the illustrated example of FIG. 4, the fuel flows from left to right from the pump 402 to the combustor 404.

The fuel enters the fuel path 424 from the pump 402 and flows through and/or across the pre-heater 418. The pre-heater 418 heats the fuel, which is then provided to the flow meter 408 and the temperature sensor 410. The operation of the flow meter 408 and the temperature sensor 410 is similar to the operation of the first and second flow meters 210, 216 and the first and second temperature sensors 212, 218, as discussed above in connection with FIG. 2. The fuel then flows through the piezoelectric metering device 406, which controls the flow rate of the fuel provided to the combustor 404. The operation of the piezoelectric metering device 406 is similar to the operation of the piezoelectric metering device 206, as discussed in connection with FIG. 2.

The PMS 400 includes first processor circuitry 412 communicatively coupled to the motor 420 and the measuring system 416, and second processor circuitry 414 communicatively coupled to the measuring system 416 and the piezoelectric metering device 406. In some examples, the first and second processor circuitry 412, 414 are implemented by the same processor circuitry communicatively coupled to the motor 420, the measuring system 416, and the piezoelectric metering device 406. The first processor circuitry 412 receives a motor output from the motor 420, a flow meter output from the flow meter 408, and a temperature sensor output from the temperature sensor 410. In some examples, the motor output is a speed of the motor 420. In some examples, the first processor circuitry 412 operates to control the motor 420.

The first processor circuitry 412 determines a pressure of the fuel based on the motor output. The first processor circuitry 412 determines a volumetric flow rate and/or a mass flow rate based on the motor output, the flow meter output, and the temperature sensor output. In some examples, the first processor circuitry 412 causes the motor 420 to one of increase or decrease the pumping speed of the motor 420 based on the volumetric flow rate and/or the mass flow rate. In some examples, the first processor circuitry 412 compares the flow rate to a maximum flow rate and reduces the pumping speed of the motor 420 when the flow rate exceeds the maximum flow rate. In some examples, the maximum flow rate is based on a maximum flow rate of system components, such as the piezoelectric metering device 406. For example, the first processor circuitry 412 reduces a speed of the motor 420 when the flow rate exceeds a piezoelectric metering device maximum flow rate of 2000 mL/min.

The second processor circuitry 414 also receives the motor output from the motor 420, the flow meter output from the flow meter 408, and the temperature sensor output from the temperature sensor 410. The second processor circuitry 414 operates to control the piezoelectric metering device 406 as the example processor circuitry 220 operates to control the piezoelectric metering device 206, as described in connection with FIG. 2.

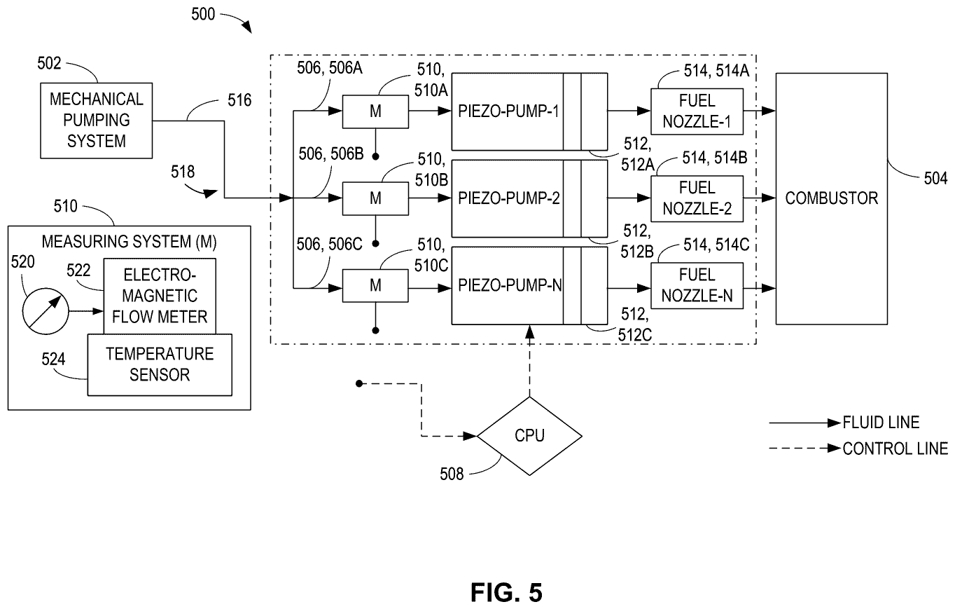

FIG. 5 is a schematic representation of an alternative example piezoelectric-based fuel metering system 500 that can implement the fuel metering system 12 of FIG. 1. The PMS 500 includes a pumping system 502, a combustor 504, a plurality of fuel lines 506, and processor circuitry 508. In the illustrated example of FIG. 5, each fuel line 506 of the plurality of fuel lines 506, includes a measuring system 510 a piezoelectric metering device 512, and a fuel nozzle 514. The PMS 500 includes one or more conduits 516 to fluidly couple the pumping system 502, the combustor 504, and the plurality of fuel lines 506. Accordingly, the conduits 516 define a fuel path 518 in which the direction of the fuel within the fuel path 518 is designated by arrowheads. In the illustrated example of FIG. 5, the fuel flows from left to right from the pumping system 502 to the combustor 504.

The fuel from the pumping system 502 enters the fuel path 518 and flows through a first fuel line 506A of the plurality of fuel lines 506, a second fuel line 506B of the plurality of fuel lines 506, and a third fuel line 506C of the plurality of fuel lines 506. In the illustrated example of FIG. 5, the plurality of fuel lines 506 includes three fuel lines 506A-C. In other examples, the plurality of fuel lines 506 includes fewer fuel lines (e.g., two fuel lines) or more fuel lines (e.g., four fuel lines, five fuel lines, etc.).

Within each of the plurality of fuel lines 506, the fuel flows through and/or across the measuring system 510. The measuring system 510 includes a pressure gauge 520, a flow meter 522, and a temperature sensor 524. The operation of the pressure gauge 520, the flow meter 522, and the temperature sensor 524 is similar to operation of the first and second pressure gauges 208, 214, the first and second flow meters 210, 216, and the first and second temperature sensors 212, 218, as discussed above in connection with FIG. 2. The fuel then flows through the piezoelectric metering device 512, which controls the flow of fluid provided to the fuel nozzle 514, and ultimately the combustor 504.

The processor circuitry 508 is communicatively coupled to the measuring system 510 and the piezoelectric metering device 512 in each of the first, second, and third fuel lines 506A-C. The processor circuitry 508 receives outputs from the measuring systems 510 and causes actuation of the piezoelectric metering device 512 based on the outputs to achieve a target volumetric flow rate and/or a target mass flow rate in each of the first, second, and third fuel lines 506A-C.

In some examples, the target volumetric flow rate and/or the target mass flow rate is equal across each fuel nozzle. In some examples, the target volumetric flow rate and/or the target mass flow rate varies across the first, second, and third fuel lines 506A-C. In some examples, the processor circuitry 508 controls a first piezoelectric metering device 512A of the first fuel line 506A, a second piezoelectric metering device 512B of the second fuel line 506B, and a third piezoelectric metering device 512C of the third fuel line 506C independently of each other. That is, the control of the first piezoelectric metering device 512A is not based on the outputs of a second measuring system 510B of the second fuel line 506B or the operation of the second piezoelectric metering device 512B.

In other examples, the processor circuitry 508 controls each of the piezoelectric metering devices 512A-C based on the outputs of all of the measuring systems 510A-C and based on the operation of the other piezoelectric metering devices 512A-C. In such examples, the processor circuitry 508 is able to coordinate the use of all of the piezoelectric metering devices 512A-C to achieve the desired total fuel flow provided to the combustor 504. For example, if the second measuring system 510B outputs a flow rate that is significantly below the target flow rate for the second fuel line 506B, the processor circuitry 508 adjusts the target flow rates in each of the first fuel line 506A, the second fuel line 506B, and the third fuel line 506C and controls the first, second, and third piezoelectric metering devices 506A-C based on the adjusted target flow rates to ensure the total amount of fuel provided to the combustor 504 meets the requirements of the combustor 504.

In some examples, each of the plurality of fuel lines 506 include features of the PMSs 200, 300, 400. For example, each of the plurality of fuel lines 506 can include any combination of the feedback loop mechanism of PMS 200, the control valve 316 of PMS 300, and/or the pump motor of PMS 400.

In the example PMS 500, the first, second, and third fuel lines 506A-C are arranged in parallel. By arranging one or more of the plurality of fuel lines 506 in parallel, each of the plurality of fuel lines 506 serves as a backup mechanism for the rest of the fuel lines. For example, when a first fuel line fails, the remaining active fuel lines may compensate for the failure by increasing the flow of fuel in the remaining active fuel lines to achieve the target fuel flow rate. Furthermore, a parallel arrangement of the fuel lines 506 enables precise control of the combustor that is being fired. In other examples, one or more of the plurality of fuel lines 506 are arranged in series. By arranging one or more of the plurality of fuel lines 506 in series, the PMS 500 is capable of achieving an increased pressure boost not achievable in traditional fuel metering systems. In some examples, the PMS 500 includes fuel lines 506 arranged in parallel as well as fuel lines 506 arranged in series.

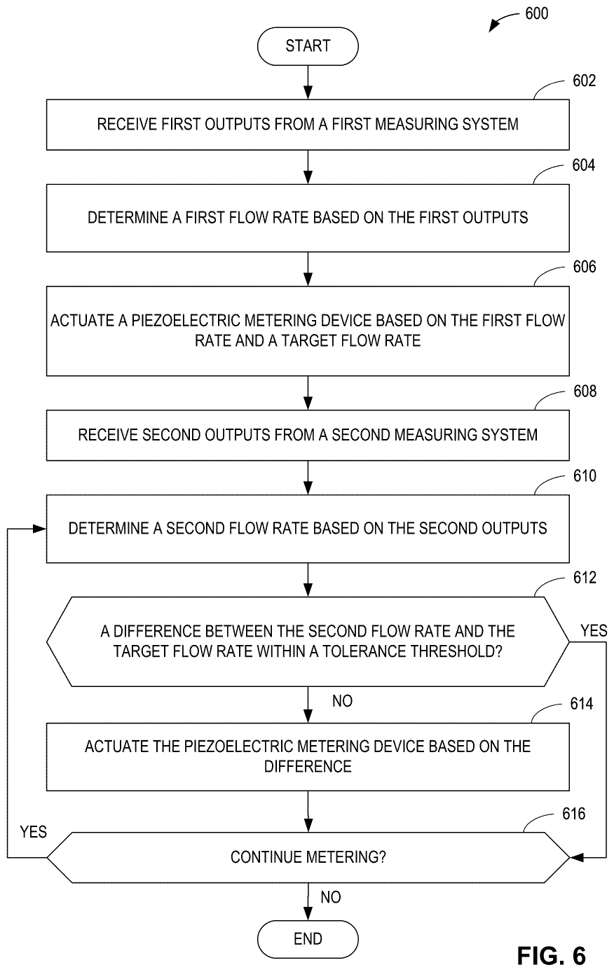

FIG. 6 is a flowchart representative of an example process 600 for metering fuel provided to a combustor using any of the example piezoelectric-based fuel metering systems 200, 300, 500, 400 of FIGS. 2-5 in accordance with the teachings of this disclosure. The process 600 begins at block 602, at which point the processor circuitry 220 receives first outputs from a first measuring system 222. The first outputs include a first pressure gauge output, a first flow meter output, and a first temperature sensor output, for example. For example, the first flow meter output includes a velocity of the fuel as it flows through the first flow meter 210.

At block 604, the processor circuitry 220 determines a first flow rate based on the first outputs. For example, the processor circuitry 220 determines the first volumetric flow rate based on a velocity of the fuel measured by the first flow meter 210 and a cross-sectional area of a passage of the first flow meter 210. The processor circuitry 220 can determine the first mass flow rate based on the first volumetric flow rate, the first pressure gauge output, and the first temperature output. The processor circuitry 220 calculates the first mass flow rate by determining a density of the fuel at the measured pressure and temperature from the first pressure gauge output and the first temperature output, respectively, and multiplying the density by the volumetric flow rate. For example, with a pressure gauge output of 5 MPa, a temperature output of 0 degrees Celsius, and a flow meter output of 500 ml/min, the processor circuitry calculates a mass flow rate of 0.13 kg/hr.

At block 606, the processor circuitry 220 actuates the piezoelectric metering device 206 based on the first flow rate and a target flow rate. For example, the processor circuitry 220 actuates the piezoelectric metering device 206 based on at least one of the first volumetric flow rate or the first mass flow rate and at least one of a corresponding target volumetric flow rate or target mass flow rate. For example, the processor circuitry 220 compares the first mass flow rate to a target mass flow rate and determine the first mass flow rate is higher than the target mass flow rate. In such an example, the processor circuitry 220 actuates the piezoelectric metering device 206 to decrease flow rate from the first flow rate to the target flow rate.

At block 608, the processor circuitry 220 receives second outputs from a second measuring system 224 located downstream of the piezoelectric metering device 206. The second outputs include a second pressure gauge output, a second flow meter output, and/or a second temperature sensor output, for example. For example, the second flow meter output includes a velocity of the fuel as it flows through the second flow meter 216.

At block 610, the processor circuitry 220 determines a second flow rate based on the second outputs. For example, the processor circuitry 220 determines a second volumetric flow rate and a second mass flow rate based on the second outputs.

At block 612, the processor circuitry 220 determines whether a difference between the second flow rate and the target flow rate falls within a tolerance threshold. For example, the processor circuitry 220 determines whether a difference between the second volumetric flow rate and the target volumetric flow rate and/or a difference between the second mass flow rate and the target mass flow rate falls within a tolerance threshold. For example, if the target mass flow rate is 500 kg/sec and the tolerance threshold is 50 kg/sec, the processor circuitry 220 determines that the difference falls within the tolerance threshold if the second mass flow rate is at or between the values of 450 kg/sec and 550 kg/sec. When the processor circuitry 220 determines the difference falls within the tolerance threshold (e.g., block 612 has an output of “YES”), the process 600 proceeds to block 616. When the processor circuitry 220 determines the difference does not fall within the tolerance threshold (e.g., block 612 has an output of “NO”), the process 600 proceeds to block 614, where the processor circuitry 220 actuates the piezoelectric metering device 206 based on the difference. For example, when the processor circuitry 220 determines the second mass flow rate is higher than the target mass flow rate, the processor circuitry 220 actuates the piezoelectric metering device 206 to decrease the mass flow rate. For example, the processor circuitry 220 may adjust the frequency at which the piezoelectric element of the piezoelectric metering device 206 moves, causing an increase in the restriction of the passage for fuel flow of the piezoelectric metering device 206, thereby decreasing the fuel flow rate.

At block 616, the processor circuitry 220 determines whether to continue metering the flow of fuel. For example, the processor circuitry 220 may determine whether to continue metering the fuel based on a flight stage, a user input, a predetermined time period for metering, etc. When the processor circuitry 220 determines continued metering is warranted (e.g., block 616 has an output of “YES”), the process returns to block 610. When the processor circuitry 220 determines continued monitoring is not desirable (e.g., block 616 has an output of “NO”), the process 600 ends.

From the foregoing, it will be appreciated that example systems, apparatus, articles of manufacture, and methods have been disclosed that provide precise metering of the fuel provided to a combustor, improving the accuracy of fuel delivery over known systems, leading to increased efficiency in fuel combustion. Bleed air systems disclosed herein regulate the flow of fuel provided to a combustor using a piezoelectric metering device and a measuring system including a pressure gauge, a flow meter, and a temperature sensor. Disclosed examples include different components and/or sub-systems in addition to the piezoelectric metering device. While each example disclosed herein provides precise fuel metering, different configurations offer additional benefits, such as providing a pressure boost within the system and/or providing redundancies in the event of component failure. Example systems, apparatus, articles of manufacture, and method disclosed herein also provide for a feedback loop to ensure proper functionality of the piezoelectric metering device.

Further examples are provided by the subject matter of the following clauses:

A fuel metering system includes a piezoelectric metering device to meter a flow of a fuel, the piezoelectric metering device fluidly coupled to a pump and a fuel nozzle; a flow meter fluidly coupled between the piezoelectric metering device and the pump; a temperature sensor fluidly coupled between the piezoelectric metering device and the pump; and at least one processor circuit to: determine a mass flow rate of the fuel based on a pressure of the fuel, a first output of the flow meter, and a second output of the temperature sensor; and actuate the piezoelectric metering device based on the determined mass flow rate and a target mass flow rate.

The fuel metering system of any preceding clause, wherein the pressure is a first pressure, the flow meter is a first flow meter, the temperature sensor is a first temperature sensor, and the determined mass flow rate is a first mass flow rate, further including a second flow meter and a second temperature sensor downstream of the piezoelectric metering device, one or more of the at least one processor circuit to: determine a second mass flow rate based on a second pressure, a third output from the second flow meter, and a fourth output from the second temperature sensor; and adjust the piezoelectric metering device based on the second mass flow rate and the target mass flow rate.

The fuel metering system of any preceding clause, wherein one or more of the at least one processor circuit is to determine the pressure of the fuel upstream of the piezoelectric metering device based on a speed of a motor of the pump.

The fuel metering system of any preceding clause, wherein one or more of the at least one processor circuit is to one of increase or decrease the speed of the motor based on the first output.

The fuel metering system of any preceding clause, further including a control valve fluidly coupled between the flow meter and the piezoelectric metering device.

The fuel metering system of any preceding clause, wherein one or more of the at least one processor circuit is to actuate the control valve to one of increase or decrease a flow of fuel through the control valve based on, at least in part, the first output.

The fuel metering system of any preceding clause, wherein the piezoelectric metering device is a first piezoelectric metering device, further including a second piezoelectric metering device arranged in parallel with the first piezoelectric metering device.

The fuel metering system of any preceding clause, wherein the flow meter is a first flow meter, and the temperature sensor is a first temperature sensor, further including a second flow meter, and a second temperature sensor arranged in series with the second piezoelectric metering device and in parallel with the first flow meter, the first temperature sensor, and the first piezoelectric metering device.

The fuel metering system of any preceding clause, wherein one or more of the at least one processor circuit is to actuate the second piezoelectric metering device independent of the first piezoelectric metering device.

The fuel metering system of any preceding clause, wherein one or more of the at least one processor circuit is to actuate the second piezoelectric metering device based on at least one of the pressure, the first output, the second output, the determined mass flow rate, or the target mass flow rate.

The fuel metering system of any preceding clause, wherein the piezoelectric metering device is a first piezoelectric metering device, further including a second piezoelectric metering device arranged in series with the first piezoelectric metering device.

A gas turbine engine for an aircraft includes a combustion section; and a fuel system to provide fuel to the combustion section, the fuel system including: a pump; a nozzle fluidly connected to the pump; a piezoelectric metering device fluidly coupled between the pump and the nozzle; a measuring system fluidly coupled between the pump and the piezoelectric metering device, the measuring system including a flow meter and a temperature sensor; and at least one processor circuit to: determine a mass flow rate based on a pressure, a first output of the flow meter, and a second output of the temperature sensor; and actuate the piezoelectric metering device based on the determined mass flow rate and a target mass flow rate.

The gas turbine engine of any preceding clause, wherein, to actuate the piezoelectric metering device, one or more of the at least one processor circuit is to cause a diaphragm of the piezoelectric metering device to vibrate at a frequency, the frequency based on a difference between the mass flow rate and the target mass flow rate.

The gas turbine engine of any preceding clause, wherein the pressure is a first pressure and the measuring system is a first measuring system, the fuel system further including a second measuring system fluidly coupled between the piezoelectric metering device and the nozzle, one or more of the at least one processor circuit to: determine a second mass flow rate based on a second pressure, a third output, and a fourth output of the second measuring system; and adjust the piezoelectric metering device based on the second mass flow rate and the target mass flow rate.

The gas turbine engine of any preceding clause, wherein the fuel system further includes a control valve fluidly coupled between the measuring system and the piezoelectric metering device, and one or more of the at least one processor circuit is to actuate the control valve to one of increase or decrease a flow of fuel through the control valve based on, at least in part, the first output.

The gas turbine engine of any preceding clause, wherein the piezoelectric metering device is a first piezoelectric metering device, further including a second piezoelectric metering device arranged in parallel with the first piezoelectric metering device.

The gas turbine engine of any preceding clause, wherein one or more of the at least one processor circuit is to actuate the second piezoelectric metering device independent of the first piezoelectric metering device.

A method includes determining, by at least one processor circuit, a first mass flow rate of the fuel based on a first output of a first flow meter and a second output of a first temperature sensor; actuating, by one or more of the at least one processor circuit, a piezoelectric metering device based on the first mass flow rate and a target mass flow rate, the piezoelectric metering device fluidly coupled to the first flow meter and the first temperature sensor; determining a second mass flow rate based on a third output of a second flow meter and a fourth output of a second temperature sensor; determining a difference between the second mass flow rate and the target mass flow rate exceeds a threshold; and adjusting, in response to the determination the difference exceeds the threshold, the piezoelectric metering device based on the difference.

The method of any preceding clause, further including actuating a control valve fluidly coupled to the piezoelectric metering device to one of increase or decrease a flow of fuel through the control valve based on, at least in part, the first output.

The method of any preceding clause, wherein the piezoelectric metering device is a first piezoelectric metering device arranged in parallel with a second piezoelectric metering device, further including actuating the second piezoelectric metering device independent of the first piezoelectric metering device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A fuel metering system comprising:
a first piezoelectric metering device to meter a flow of a fuel, the first piezoelectric metering device fluidly coupled to a pump and a fuel nozzle and arranged in series with a second piezoelectric metering device;
a flow meter fluidly coupled between the first piezoelectric metering device and the pump;
a temperature sensor fluidly coupled between the first piezoelectric metering device and the pump; and
at least one processor circuit configured to:
determine a mass flow rate of the fuel based on a pressure of the fuel, a first output of the flow meter, and a second output of the temperature sensor; and
actuate the first piezoelectric metering device based on the mass flow rate and a target mass flow rate.

2. The fuel metering system of claim 1, wherein the pressure is a first pressure, the flow meter is a first flow meter, the temperature sensor is a first temperature sensor, the mass flow rate is a first mass flow rate, and the fuel metering system further includes a second flow meter and a second temperature sensor downstream of the first piezoelectric metering device, and wherein one or more of the at least one processor circuit is configured to:
determine a second mass flow rate based on a second pressure, a third output from the second flow meter, and a fourth output from the second temperature sensor; and
adjust the first piezoelectric metering device based on the second mass flow rate and the target mass flow rate.

3. The fuel metering system of claim 1, wherein one or more of the at least one processor circuit is configured to determine the pressure of the fuel based on a speed of a motor of the pump.

4. The fuel metering system of claim 3, wherein the one or more of the at least one processor circuit is configured to one of increase or decrease the speed of the motor based on the first output.

5. The fuel metering system of claim 1, further including a control valve fluidly coupled between the flow meter and the first piezoelectric metering device.

6. The fuel metering system of claim 5, wherein one or more of the at least one processor circuit is configured to actuate the control valve to one of increase or decrease the flow of the fuel through the control valve based on, at least in part, the first output.

7. The fuel metering system of claim 1, wherein the second piezoelectric metering device is arranged in parallel with a third piezoelectric metering device.

8. The fuel metering system of claim 7, wherein the flow meter is a first flow meter, the temperature sensor is a first temperature sensor, and the fuel metering system further includes a second flow meter and a second temperature sensor arranged in series with the second piezoelectric metering device and in parallel with a third flow meter, a third temperature sensor, and the third piezoelectric metering device.

9. The fuel metering system of claim 7, wherein one or more of the at least one processor circuit is configured to actuate the second piezoelectric metering device independent of the third piezoelectric metering device.

10. The fuel metering system of claim 7, wherein one or more of the at least one processor circuit is configured to actuate the second piezoelectric metering device based on at least one of the pressure, the first output, the second output, the determined mass flow rate, or the target mass flow rate.

11. (canceled)

12. A gas turbine engine for an aircraft, the gas turbine engine comprising:
a combustion section; and
a fuel system to provide a fuel to the combustion section, the fuel system including:
a pump;
a nozzle fluidly connected to the pump;
a first piezoelectric metering device fluidly coupled between the pump and the nozzle and arranged in series with a second piezoelectric metering device;
a measuring system fluidly coupled between the pump and the first piezoelectric metering device, the measuring system including a flow meter and a temperature sensor; and
at least one processor circuit configured to:
determine a mass flow rate based on a pressure of the fuel, a first output of the flow meter, and a second output of the temperature sensor; and
actuate the first piezoelectric metering device based on the mass flow rate and a target mass flow rate.

13. The gas turbine engine of claim 12, wherein, to actuate the first piezoelectric metering device, one or more of the at least one processor circuit is configured to cause a diaphragm of the first piezoelectric metering device to vibrate at a frequency, the frequency based on a difference between the mass flow rate and the target mass flow rate.

14. The gas turbine engine of claim 12, wherein the measuring system is a first measuring system and the pressure is a first pressure of the fuel flowing through the first measuring system, the fuel system further including a second measuring system fluidly coupled between the first piezoelectric metering device and the nozzle, and wherein one or more of the at least one processor circuit is configured to:
determine a second mass flow rate based on a second pressure of the fuel flowing through the second measuring system, a third output, and a fourth output of the second measuring system; and
adjust the first piezoelectric metering device based on the second mass flow rate and the target mass flow rate.

15. The gas turbine engine of claim 12, wherein the fuel system further includes a control valve fluidly coupled between the measuring system and the first piezoelectric metering device, and one or more of the at least one processor circuit is configured to actuate the control valve to one of increase or decrease a flow of the fuel through the control valve based on, at least in part, the first output.

16. The gas turbine engine of claim 12, wherein the second piezoelectric metering device is arranged in parallel with a third piezoelectric metering device.

17. The gas turbine engine of claim 16, wherein one or more of the at least one processor circuit is configured to actuate the second piezoelectric metering device independent of the third piezoelectric metering device.

18. A method for metering a fuel in a gas turbine engine, the method comprising:
determining, by at least one processor circuit, a first mass flow rate of the fuel based on a first pressure of the fuel upstream of a piezoelectric metering device, a first output of a first flow meter, and a second output of a first temperature sensor, wherein the first pressure of the fuel is based on a speed of a motor of a pump;
actuating, by one or more of the at least one processor circuit, the piezoelectric metering device based on the first mass flow rate and a target mass flow rate, the piezoelectric metering device fluidly coupled to the first flow meter and the first temperature sensor, wherein one or more of the at least one processor circuit is to increase or decrease to the speed of the motor based on the first output;
determining a second mass flow rate based on a second pressure of the fuel downstream of the piezoelectric metering device, a third output of a second flow meter, and a fourth output of a second temperature sensor, the second flow meter and the second temperature sensor fluidly coupled to the piezoelectric metering device;
determining that a difference between the second mass flow rate and the target mass flow rate exceeds a threshold; and
adjusting, in response to the determination that the difference exceeds the threshold, the piezoelectric metering device based on the difference.

19. The method of claim 18, further including actuating a control valve fluidly coupled to the piezoelectric metering device to one of increase or decrease a flow of the fuel through the control valve based on, at least in part, the first output.

20. The method of claim 18, wherein the piezoelectric metering device is a first piezoelectric metering device arranged in parallel with a second piezoelectric metering device, and further including actuating the second piezoelectric metering device independently of the first piezoelectric metering device.
